(19) United States
(12) Patent Application Publication
(10) Pub. No.: US 2018/0067561 A1
(43) Pub. Date: Mar. 8, 2018

(54) HAPTIC EFFECT HANDSHAKE UNLOCKING

(71) Applicant: Immersion Corporation, San Jose, CA (US)

(72) Inventors: Erin RAMSAY, Dollard des Ormeaux (CA); Masashi KOBAYASHI, Tokyo (JP); Kurt-Eerik STAHLBERG, Montreal (CA); Robert W. HEUBEL, San Leandro, CA (US)

(21) Appl. No.: 15/811,054

(22) Filed: Nov. 13, 2017

Related U.S. Application Data
(63) Continuation of application No. 14/299,541, filed on Jun. 9, 2014.
(60) Provisional application No. 61/833,178, filed on Jun. 10, 2013.
(60) Provisional application No. 61/832,618, filed on Jun. 7, 2013.

(51) Int. Cl. G06F 3/01; G06F 3/0488; G06F 21/70; G06F 21/31; G06F 1/16

(52) U.S. Cl. CPC G06F 3/016; G06F 3/04883; G06F 21/70; G06F 2200/1636; G06F 1/1684; G06F 3/017; G06F 1/1694; G06F 21/31

(57) ABSTRACT

A system that unlocks itself or another device or electronic media enters an unlocked mode by playing a predetermined haptic effect and in response receiving a gesture based interaction input from a user. The system compares the interaction input to a stored predefined interaction input and transitions to the unlocked mode if the interaction input substantially matches the stored predefined interaction input.

### CROSS REFERENCE TO RELATED APPLICATIONS

This application claims priority of Provisional Patent Application Ser. No. 61/832,618, filed on Jun. 7, 2013, and Provisional Patent Application Ser. No. 61/833,178, filed on Jun. 10, 2013. The contents of each is hereby incorporated by reference.

### FIELD

One embodiment is directed generally to haptic effects, and in particular to using haptic effects for an unlocking functionality.

### BACKGROUND INFORMATION

Many mobile devices and other types of devices have a locked mode. The locked mode may be used to prevent inadvertent operation of a touchscreen display (e.g., while the device is in a user's pocket or purse or when another object is placed against the device). The locked mode may also be used to prevent an unauthorized person from using the device. A device typically enters the locked mode when a user presses a specific button or a series of buttons or when it has been idle for a certain period of time. When a user desires to unlock a device, the user will typically be required to drag a slide bar and press a specific button or a series of buttons that form a password, or trace a predefined pattern on the touchscreen. However, with many of the known unlocking schemes, an intruder looking over the shoulder of the user may be able to later duplicate the unlocking “sequence”.

### SUMMARY

One embodiment is a system that unlocks itself or another device or electronic media. The system enters an unlocked mode by playing a predetermined haptic effect and in response receiving a gesture based interaction input from a user. The system compares the interaction input to a stored predefined interaction input and transitions to the unlocked mode if the interaction input substantially matches the stored predefined interaction input.

### BRIEF DESCRIPTION OF THE DRAWINGS

FIG. 1 is a block diagram of a haptically-enabled system in accordance with one embodiment of the present invention.

FIG. 2 is a flow diagram of a haptic effect handshake module of FIG. 1 when performing device unlocking functionality using a haptic effect handshake in accordance with embodiments of the present invention.

### DETAILED DESCRIPTION

One embodiment uses a haptic effect “handshake” to unlock a device or to provide other unlocking functionality. The handshake includes a predefined haptic effect played by the device that is recognized by the user. In response, the user provides an input such as a predefined tapping sequence, possibly with predefined timing relative to the playing haptic effect. If the user input matches, the device is unlocked.

A “haptic effect” or “haptic feedback” for mobile devices can include kinesthetic feedback (such as active and resistive force feedback) and/or tactile feedback (such as vibration, texture, and heat). Haptic feedback can provide cues that enhance and simplify the user interface. Specifically, vibration effects, or vibrotactile haptic effects, may be useful in providing cues to users of electronic devices to alert the user to specific events, or provide realistic feedback to create greater sensory immersion within a simulated or virtual environment. In conjunction with embodiments of the present invention, haptic feedback is used as a portion of a device unlocking scheme.

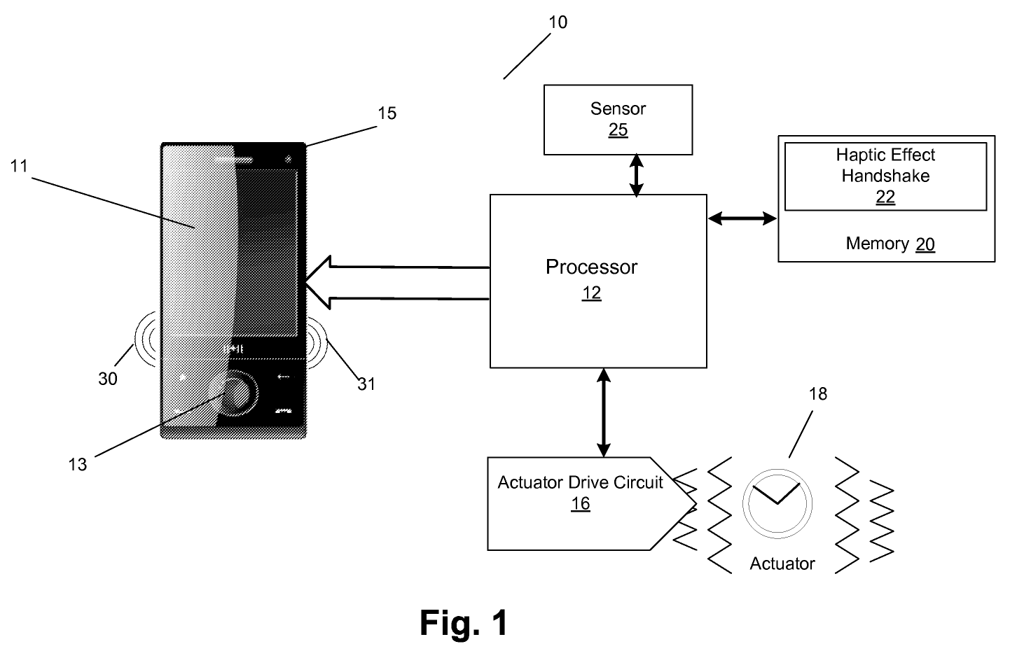

FIG. 1 is a block diagram of a haptically-enabled system 10 in accordance with one embodiment of the present invention. System 10 includes a touch sensitive surface or “touchscreen” 11 mounted within a housing 15, and may include mechanical keys/buttons 13.

Internal to system 10 is a haptic feedback system that generates haptic effects on system 10 and includes a processor or controller 12. Coupled to processor 12 is a memory 20, and an actuator drive circuit 16 which is coupled to an actuator 18. Processor 12 may be any type of general purpose processor, or could be a processor specifically designed to provide haptic effects, such as an application-specific integrated circuit (“ASIC”). Processor 12 may be the same processor that operates the entire system 10, or may be a separate processor. Processor 12 can decide what haptic effects are to be played and the order in which the effects are played based on high level parameters. In general, the high level parameters that define a particular haptic effect include magnitude, frequency and duration. Low level parameters such as streaming motor commands could also be used to determine a particular haptic effect. A haptic effect may be considered “dynamic” if it includes some variation of these parameters when the haptic effect is generated or a variation of these parameters based on a user's interaction. The haptic feedback system in one embodiment generates vibrations 30, 31 on system 10.

Processor 12 outputs the control signals to actuator drive circuit 16, which includes electronic components and circuitry used to supply actuator 18 with the required electrical current and voltage (i.e., “motor signals”) to cause the desired haptic effects. System 10 may include more than one actuator 18, and each actuator may include a separate drive circuit 16, all coupled to a common processor 12. One or more sensors 25 are coupled to processor 12. One type of sensor 25 may be an accelerometer that recognizes “tapping” gestures from a user tapping with a finger or other object on touchscreen 11, or on another portion of system 10 such as housing 15. The accelerometer may also recognize the magnitude of each tapping gesture. In other embodiments, system 10 includes a pressure sensing surface that can recognize tapping gestures without needing an accelerometer. Sensor 25 may also recognize other gestures from a user interacting with system 10, such as shaking, etc.

Memory 20 can be any type of storage device or computer-readable medium, such as random access memory (“RAM”) or read-only memory (“ROM”). Memory 20 stores instructions executed by processor 12. Among the instructions, memory 20 includes a haptic effect handshake module 22 which are instructions that, when executed by processor 12, provides device unlocking functionality using a haptic effect handshake, as disclosed in more detail below. Memory 20 may also be located internal to processor 12, or any combination of internal and external memory.

Actuator 18 may be, for example, an electric motor, an electro-magnetic actuator, a voice coil, a shape memory alloy, an electro-active polymer, a solenoid, an eccentric rotating mass motor (“ERM”), a linear resonant actuator (“LRA”), a piezoelectric actuator, a high bandwidth actuator, an electroactive polymer (“EAP”) actuator, an electrostatic friction display, or an ultrasonic vibration generator. In alternate embodiments, system 10 can include one or more additional actuators, in addition to actuator 18 (not illustrated in FIG. 1). Actuator 18 is an example of a haptic effect output device configured to output haptic effects, such as vibrotactile haptic effects, electrostatic friction haptic effects, or deformation haptic effects, in response to a drive signal.

In addition to or in place of actuator 18, system 10 may include other types of haptic output devices (not shown) that may be non-mechanical or non-vibratory devices such as devices that use electrostatic friction (“ESF”), ultrasonic surface friction (“USF”), devices that induce acoustic radiation pressure with an ultrasonic haptic transducer, devices that use a haptic substrate and a flexible or deformable surface or shape changing devices and that may be attached to a user's body, devices that provide projected haptic output such as a puff of air using an air jet, etc.

System 10 may be any type of device or handheld/mobile device, such as a cellular telephone, personal digital assistant (“PDA”), smartphone, computer tablet, gaming console, remote control, or any other type of device that includes a haptic effect system that includes one or more actuators. System 10 may be a wearable device such as a bracelet, wrist bands, headbands, eyeglasses, rings, leg bands, arrays integrated into clothing, etc., or any other type of device that a user may wear on a body or can be held by a user and that is haptically enabled. The user interface of system 10 may be a touch sensitive surface, or can be any other type of user interface such as a mouse, touchpad, mini-joystick, scroll wheel, trackball, game pads or game controllers, etc. Not all elements illustrated in FIG. 1 will be included in each embodiment of system 10. In many embodiments, only a subset of the elements are needed.

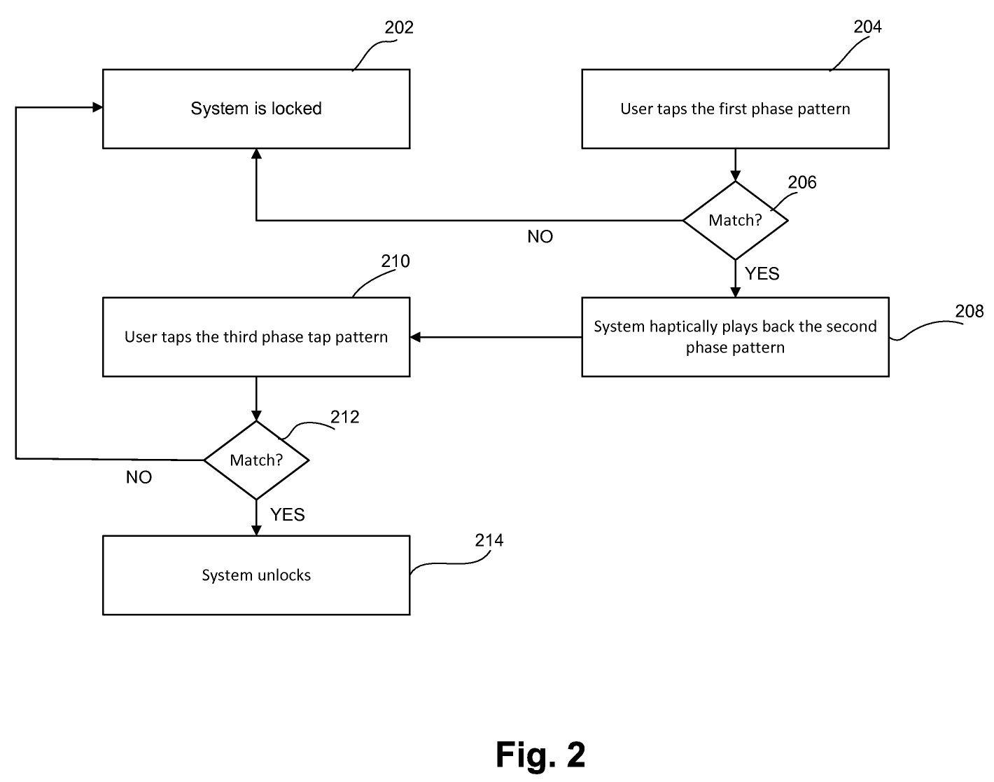

FIG. 2 is a flow diagram of haptic effect handshake module 16 of FIG. 1 when performing device or any other type of unlocking functionality using a haptic effect handshake in accordance with embodiments of the present invention. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

Before the functionality of FIG. 2 is implemented, a setup is implemented that involves storing one or more predefined tapping inputs. For the embodiment of FIG. 2, up to three stages may be implemented, and a unique predefined tapping input may be stored for each stage. In other embodiments where less stages are implemented, or unique predefined tapping inputs are not required, only a single predefined tapping input may be stored.

The user can record a separate tap pattern in each stage that functions as the predefined tapping input. The user will tap on touchscreen 11 or any other portion of system 10. System 10 will records three data points in one embodiment: the gap between taps, the duration of the tap and the strength of the tap. The strength is measured with the built-in accelerometer 25 and the gap and duration are measured with a system timer (not shown). System 10 can play the pattern back haptically at each stage (i.e., reproduce the tapping pattern using actuator 18) to make sure the user is satisfied with the pattern. A pattern recording can be repeated. In another embodiment, a change or rate of change of a finger touch area can be used to determine strength of tapping.

Once one or more unique predefined tapping inputs are stored, at 202 of FIG. 2 system 10 starts in a locked state. System 10 may be locked in response to a specific user input (i.e., a sequence of keys), an idle time-out, or due to any other event.

In general, in a three phase unlocking embodiment as shown in FIG. 2, the system will first listen to tapping on the device and when it detects the correct tap pattern for this first phase, it will play the second phase pattern and wait for the correct third phase pattern. The second phase will only start playing when the first stage pattern has been tapped correctly. If the third phase pattern is tapped correctly the unlock procedure will commence. Otherwise the system will remain locked.

Specifically, at 204, in a first optional phase, the user taps a first phase tap pattern. At 206, if it is determined that this tap pattern matches a predefined tapping input for the first phase by comparing to the stored predefined tapping input, functionality continues to the second phase at 208. If there is no match at 206, functionality continues to 202 where system 10 remains locked. The comparison at 206, and later at 212, in one embodiment is conducted by comparing each tap in the pattern heuristically. If the system determines that a pattern is “close enough”, a match will be confirmed. A margin for error is included because a user is not typically capable of tapping a pattern identically every time.

At 208, system 10 plays back the second phase pattern (i.e., a unique stored predefined tapping input). The second phase pattern may also be a predefined haptic effect that is not based on a tapping input. The second phase pattern is the initial haptic effect “handshake”. The second phase pattern may act as a simple cue for the user to enter the final unlock sequence (at 210) or also as a haptic hint for the final sequence. For example, a haptic effect that feels like “shave and a haircut” (i.e., the simple 7-note musical couplet or riff popularly used at the end of a musical performance, usually for comic effect) may be a hint to now input “two bits” as two taps on the user device at 210 to complete the playing. As another example, the haptic effect at 208 may be a vibration with a linearly increasing frequency. At the timing of an approximate specific frequency level, system 10 may look for the user input to be initiated at approximately that moment.

After the second phase pattern is played, at 210 the user is required to input a third phase tap pattern. This is the second part of the haptic effect handshake. Similar to at 206, at 212 it is determined if this tap pattern matches a predefined tapping input for the first phase.

If there is a match at 221, the system is unlocked at 214. If there is no match at 221, functionality continues to 202 where system 10 remains locked. In other embodiments, rather than unlocking the system that receives inputs at 214, a separate system can be unlocked. For example, system 10 may be a wearable bracelet, and successfully executing 210 may remotely unlock a door. Further, something other than a device or structure may be unlocked. For example, the functionality of FIG. 2 may be used for unlocking a document, image, or other media or file.

As described, the first phase tap pattern at 204 of FIG. 2 may not be included in some embodiments, in which case the two phase haptic effect handshake at 208 and 210 is used for unlocking. Further, in addition to the recorded input being tapping gestures, other embodiments allow for other input gestures to be recorded as part of the unlocking sequences. For example, finger traces, device shaking, and similar gestures might also be recorded. Further, embodiments can be combined with other non-haptic effect based security methods such as fingerprint/retinal/voice recognition to further enhance the security of the unlocking procedure. For example, the first phase at 204 may use fingerprint recognition rather than a tapping input.

In some embodiments, the unlock sequences include blocks in the timeline where user input is not being compared to the defined unlock sequences. This allows the user to give “false inputs” for greater visual security from spying eyes. Further, for some embodiments system 10 does not have any visible or audible parts beyond a possible help screen that could be shown to aid the user in different stages of the unlock and/or record procedure. For example, no keys or predefined positions are displayed on touchscreen 11. This makes it more difficult for a third party to determine an input sequence by “shoulder surfing.”

The predefined stored tapping sequences may also contain time delays to further enhance the security of the unlocking timelines. For example, the user might add a time delay after the end of the initial handshake at 208 and before the input of the final unlock sequence at 210.

In one embodiment, for the stored predefined tapping sequences, three properties are stored for each tap: (1) gap to the previous tap (in ms); (2) duration of the tap (in ms); and (3) the strength of the tap (i.e., acceleration). The gap and duration can be measured using a system timer on touch down and touch up events, and strength can be measured using the accelerometer. When a sequence is being recorded, all of the taps by the user are recorded by saving these three properties into a list.

In one embodiment, when receiving input for unlocking, such as at 210 of FIG. 2, the unlock tap sequence is similarly recorded, and when the user is done tapping (i.e., a timeout is detected) a comparison of the stored sequence and the unlock sequence is performed (i.e., at 206 and 212 of FIG. 2). The first item compared in one embodiment is the number of taps. If there are no taps in either of the sequences, the comparison fails immediately. Otherwise the difference in the number of taps is later used. Next, the gap, duration and strength of the corresponding taps in the sequences are compared. In one embodiment, both the gap and duration differences are cubed and then divided by 10,000 to create an exponential curve within a manageable range of values. The generally vague value of strength is squared and then divided by 4,000,000 for the same reason. These values are then added up to create the difference value of a single tap in the sequence. Pseudo-code for the gap, duration and strength comparison for one embodiment is as follows:

gapdiff=(|gap1−gap2|̂3)/10000

durationdiff=(|dur1−dur2|̂3)/10000

strengthdiff=((str1−str2)̂2)/4000000

tapdiff=gapdiff+durationdiff+strengthdiff

As disclosed, embodiments uses a tapping pattern in response to a haptic effect pattern to unlock a device. A tapping pattern is difficult to copy due to its complexity, yet is relatively simple to repeat if the rhythm is known. Therefore, the haptic effect handshaking is secure and relatively simple. Further, since haptic effects can only be felt by the user actually holding the device, it is difficult to spy on haptic patterns. Embodiments allow for false inputs, time delays and “haptic hints” that all greatly enhance the security of the device.

Several embodiments are specifically illustrated and/or described herein. However, it will be appreciated that modifications and variations of the disclosed embodiments are covered by the above teachings and within the purview of the appended claims without departing from the spirit and intended scope of the invention.

1-26. (canceled)

27. A non-transitory computer-readable medium having instructions stored thereon that, when executed by a processor, cause the processor to unlock a device by:
in a locked mode, receiving on the device a first user-input tap pattern that includes a first input tap or a first plurality of input taps;
determining a strength of the first input tap or respective strengths of the first plurality of input taps;
determining whether the first user-input tap pattern substantially matches a stored first user-recorded tap pattern that stores a strength of a first recorded tap or respective strengths of a first plurality of recorded taps, wherein the determining step comprises comparing the strength of the first input tap or the respective strengths of the first plurality of input taps with the strength of the first recorded tap or the respective strengths of the first plurality of recorded taps;
when the first user-input tap pattern substantially matches the stored first user-recorded tap pattern, playing a predetermined haptic effect on the device;
receiving on the device a second user-input tap pattern that is in response to the predetermined haptic effect, wherein the second user-input tap pattern includes a second input tap or a second plurality of input taps;
determining a strength of the second input tap or respective strengths of the second plurality of input taps;
determining whether the second user-input tap pattern substantially matches a stored second user-recorded tap pattern that stores a strength of a second user-recorded tap or respective strengths of a second plurality of user-recorded taps, wherein the determining step comprises comparing the strength of the second input tap or the respective strengths of the second plurality of input taps with the strength of the second user-recorded tap or the respective strengths of the second plurality of user-recorded taps; and
unlocking the device when the second user-input tap pattern substantially matches the stored second user-recorded tap pattern.

28. The non-transitory computer-readable medium of claim 27, wherein the instructions cause the processor to determine the strength of the first input tap or respective strengths of the first plurality of input taps using an accelerometer.

29. The non-transitory computer-readable medium of claim 27, wherein the instructions cause the processor to determine the strength of the first input tap or respective strengths of the first plurality of input taps using a pressure sensitive surface.

30. The non-transitory computer-readable medium of claim 27, wherein the stored second user-recorded tap pattern further stores for each tap of the second plurality of recorded taps, a gap to a previous tap and a duration of the tap wherein the step of determining whether the second user-input tap pattern substantially matches the second user-recorded tap pattern comprises comparing the gap and the duration for each tap of the second plurality of recorded taps with a gap and a duration of a tap of the second plurality of input taps.

31. The non-transitory computer-readable medium of claim 27, wherein the second user-input tap pattern comprises at least one of a finger trace or a shaking of the device.

32. The non-transitory computer-readable medium of claim 27, wherein the predefined haptic effect comprises an additional user-recorded tap pattern.

33. A method of unlocking a device, the method comprising:
in a first stage in which the device is in a locked mode:
receiving on the device a first user-input tap pattern that includes a first input tap or a first plurality of input taps,
determining a strength of the first input tap or respective strengths of the first plurality of input taps, and
determining whether the first user-input tap pattern substantially matches a stored first user-recorded tap pattern that stores a strength of a first recorded tap or respective strengths of a first plurality of recorded taps, wherein the determining step comprises comparing the strength of the first input tap or the respective strengths of the first plurality of input taps with the strength of the first recorded tap or the respective strengths of the first plurality of recorded taps;
in a second stage in which the first user-input tap pattern substantially matches the stored first user-recorded tap pattern, playing a predetermined haptic effect on the device; and
in a third stage that follows the second stage:
receiving on the device a second user-input tap pattern that is in response to the predetermined haptic effect, wherein the second user-input tap pattern includes a second input tap or a second plurality of input taps,
determining a strength of the second input tap or respective strengths of the second plurality of input taps,
determining whether the second user-input tap pattern substantially matches a stored second user-recorded tap pattern that stores a strength of a second user-recorded tap or respective strengths of a second plurality of user-recorded taps, wherein the determining step comprises comparing the strength of the second input tap or the respective strengths of the second plurality of input taps with the strength of the second user-recorded tap or the respective strengths of the second plurality of user-recorded taps, and
unlocking the device if the second user-input tap pattern substantially matches the stored second user-recorded tap pattern,
wherein the method of unlocking the device includes only the first stage, the second stage, and the third stage.

34. The method of claim 33, wherein the strength of the first input tap or respective strengths of the first plurality of input taps are determined with an accelerometer.

35. The method of claim 33, wherein the strength of the first input tap or respective strengths of the first plurality of input taps are determined with a pressure sensitive surface.

36. The method of claim 33, wherein the stored second user-recorded tap pattern further stores, for each tap of the second plurality of recorded taps, a gap to a previous tap and a duration of the tap, wherein the step of determining whether the second user-input tap pattern substantially matches the second user-recorded tap pattern comprises comparing the gap and the duration for each tap of the second plurality of recorded taps with a gap and a duration of a tap of the second plurality of input taps.

37. The method of claim 33, wherein the second user-input tap pattern further comprises at least one of a finger trace or a shaking of the device.

38. The method of claim 33, wherein the predefined haptic effect comprises an additional user-recorded tap pattern.

39. A method of unlocking a device, the method comprising:
in a locked mode, receiving on the device a fingerprint input;
determining whether the fingerprint input is recognized;
in response to a determination that the fingerprint input is recognized, playing a predetermined haptic effect on the device;
receiving on the device a user-input tap pattern that is in response to the predetermined haptic effect, wherein the user-input tap pattern includes an input tap or a plurality of input taps;
determining whether the user-input tap pattern substantially matches a stored user-recorded tap pattern; and
unlocking the device if the user-input tap pattern substantially matches the stored user-recorded tap pattern.

40. The method of claim 39, further comprising determining a strength of the input tap or respective strengths of the plurality of input taps,
wherein the stored user-recorded tap pattern stores a strength of a user-recorded tap or respective strengths of a plurality of user-recorded taps, and
wherein the step of determining whether the user-input tap pattern substantially matches the stored user-recorded tap pattern comprises comparing the strength of the input tap or respective strengths of the plurality of input taps with the strength of the user-recorded tap or the respective strengths of the plurality of user-recorded taps.
